(19) United States
(12) Patent Application Publication
(10) Pub. No.: US 2023/0041158 A1
(43) Pub. Date: Feb. 9, 2023

(54) PLASTIC CLIP, PRE-ASSEMBLED FLUID LINE ARRANGEMENT AND ATTACHMENT METHOD

(71) Applicant: Cooper-Standard Automotive (Deutschland) GmbH, Schelklingen (DE)

(72) Inventor: Ludovic Guersing, Dalem (FR)

(21) Appl. No.: 17/970,921

(22) Filed: Oct. 21, 2022

Related U.S. Application Data
(63) Continuation of application No. PCT/EP2021/060177, filed on Apr. 20, 2021.

(30) Foreign Application Priority Data
Apr. 21, 2020 (EP) 20 170 668.6

(51) Int. Cl. F16L 3/10; B60T 17/04

(52) U.S. Cl. CPC F16L 3/1091; B60T 17/046; F16B 21/086

(57) ABSTRACT

A plastic clip for attaching a longitudinal element, particularly a fluid line, to a perforated sheet part, particularly a body part of a vehicle. The plastic clip comprises a base portion and a lid portion connectable or hingedly connected to the base portion so as to establish an open configuration or a closed configuration. The base portion has a semi-circular base receptacle for the longitudinal element. The lid portion has a semi-circular lid receptacle for the longitudinal element. The base receptacle and the lid receptacle, in the closed configuration, together form a circular holding portion for the longitudinal element. At least one of the base receptacle and the lid receptacle is provided with a jacket portion which is made from a material that is softer than the material of the respective receptacle. The base portion comprises a support portion from which projects a plastic rivet protrusion adapted to be inserted into a hole of the perforated sheet part.

### CROSS REFERENCE TO RELATED APPLICATIONS

This is a Continuation application of International patent application PCT/EP2021/060177, filed Apr. 20, 2021, which claims the priority of European patent application EP20170668.6, filed Apr. 21, 2020, the entire content of these earlier applications being incorporated herein by reference.

### BACKGROUND

The present application relates to a plastic clip for attaching a longitudinal element, particularly a fluid line, to a perforated sheet part, particularly a body part of a vehicle.

Secondly, the present application relates to a pre-assembled fluid line arrangement, comprising a fluid line for guiding fluid and at least one plastic clip.

Also, the present application relates to a method of attaching a longitudinal element, particularly a fluid line, to a perforated sheet part, using a plastic clip.

A plastic clip for attaching a fuel line to a body part of a vehicle is known from document DE 11 2010 002 828 B4.

The prior art plastic clip includes a rigid outer clamp and an insert attached to the clamp, wherein the insert is made from a material which is softer than the material of the clamp.

The plastic clip further comprises a stud receptacle, for axially attaching the plastic clip to a stud that protrudes from a body part of the vehicle.

Another holding element for a duct is known from document WO 2018/145889 A1.

In the field of brake lines, it is generally known to attach the brake line at a certain position of its axial extend to a perforated sheet part of a vehicle body, using a metallic bracket with rubber insert. The metallic bracket is assembled on the brake line or brake tube. The metallic bracket includes a fastening hole through which a screw can be inserted. When attaching the brake line to the body sheet part, the screw is screwed into a threaded hole of the sheet part.

The above attachment concept is based on multiple components (bracket, rubber insert, screw, washer, etc.). Further, the attachment step can be cumbersome because a screwing tool has to be used, often in an environment where a worker has only little space to insert the screw into the perforated sheet part.

### SUMMARY

In view of the above, it is an object to provide an improved attachment concept for attaching a longitudinal element to a perforated sheet part of a vehicle, wherein it is preferred if the same perforated sheet part can be used that has been used up to now in combination with the metallic bracket.

The above object may be achieved by a plastic clip for attaching a longitudinal element, particularly a fluid line, to a perforated sheet part, particularly a body part of a vehicle, comprising a base portion and a lid portion connectable or hingedly connected to the base portion so as to establish an open configuration or a closed configuration, wherein the base portion has a semi-circular base receptacle for the longitudinal element, wherein the lid portion has a semi-circular lid receptacle for the longitudinal element, wherein the base receptacle and the lid receptacle, in the closed configuration, together form a circular holding portion for the longitudinal element, wherein at least one of the base receptacle and the lid receptacle is provided with a jacket portion which is made from a material that is softer than the material of the respective receptacle, wherein the base portion comprises a support portion from which projects a plastic rivet protrusion adapted to be inserted into a hole of the perforated sheet part, particularly a threaded hole of the perforated sheet part.

Further, the above object may be achieved by a pre-assembled fluid line arrangement, comprising a fluid line for guiding fluid and at least one plastic clip according to the present application, wherein the plastic clip is closed so that the circular holding portion encloses the fluid line and is pre-mounted thereto at a pre-defined attachment position along the extension of the fluid line.

Finally, the above object may be achieved by a method of attaching a longitudinal element, particularly a fluid line, to a perforated sheet part, particularly a body part of a vehicle, comprising the steps of: providing a plastic clip according to any one of claims 1 to 12 and pre-mounting the plastic clip to the longitudinal element; and attaching the plastic clip to the perforated sheet part, wherein the attachment step includes inserting the rivet protrusion into a hole of the perforated sheet part, particularly into a threaded hole thereof.

The present application seeks to improve the assembly process of attaching a longitudinal element like a fluid line to a perforated sheet part, particularly a body part of a vehicle.

The perforated sheet part includes a hole, which is preferably provided with an internal thread. While the prior art involved screwing a screw into the threaded hole, in order to attach a metallic bracket, the present application includes a plastic clip that has a plastic rivet protrusion. The plastic rivet protrusion can be inserted into the hole, particularly a threaded hole. The threaded hole may be the same as has been formally used in combination with the screw and the metallic bracket.

Therefore, the plastic clip replaces both the metallic bracket and the screw, and possibly a washer or the like used in combination therewith.

The plastic rivet protrusion is formed such that it engages in or at a shoulder of a threaded hole, so that the a similar or even a better axial and radial resistance after assembly can be achieved.

In addition, the plastic clip can be pre-assembled to the fluid line so as to form a pre-assembled fluid line arrangement. This further facilitates the assembly process.

The rivet protrusion is particularly adapted to resist axial forces of at least 250 N, preferably at least 400 N. Further, external torques of more than 0.5 nM, preferably of more than 5 nM can be resisted.

A material for the base portion and the lid portion is preferably PA, particularly PA 66. As a material for the jacket portion, any rubber material or for example TPE (thermoplastic elastomer) is preferred, particularly in a thickness of approximately 1 mm to 2 mm.

The jacket portion is preferably held on the respective base portion or lid portion such that it stays in its specified position during transportation and handling. The jacket portion can be attached to the respective receptacle by means of positive and/or frictional engagement. Further, it is possible to attach the jacket portion to the receptacle by means of an adhesive. Preferably, a 2K-injection molding step is conducted for molding the plastic clip together with the jacket portion in one molding step.

The plastic clip is compliant with thermal requirements as typically occur in vehicle applications. Further, the plastic clip is able to provide an electrical resistance between the fluid line and the body part of the vehicle of at least 100 Ohm.

In the closed configuration, the base portion and the lid portion can hold the longitudinal element such that the clip remains in its position, even if a torque of 1 Nm is applied to the longitudinal element. With an adjustment of 2K jacket thickness, this torque resistance level can be reduced to allow small angular rotation and then improve pre-positioning of the rivet protrusion into the perforated sheet part. Usually, a torque of 0.1 to 0.3 nM is considered to be typical for manual assembly.

The fluid line may be a brake line, an oil line, a fuel line, etc. The fluid line may be rigid or flexible. The term line encompasses a hose, a tube, a pipe, etc.

Semi-circular may define an angle between 100° and 260°, and preferably defines an angle of 180°.

The above object is achieved in full.

In a preferred embodiment, the support portion is provided at an underside of a main part of the base portion and/or the support portion is provided at an extension portion of the base portion.

The extension portion may be a flat portion which extends essentially parallel to a closure plane between the base portion and the lid portion. Preferably, the extension portion extends in a direction transverse to the direction, in which the rivet protrusion projects from the support portion. Preferably, the rivet protrusion and the extension portion are aligned under an angle of 90°.

The extension portion can contribute to a stable attachment to the perforated sheet part.

The base portion and the lid portion may be different parts that are separate from each other in the open configuration.

However, it is preferred if the base portion and the lid portion are connected via an integral hinge.

In this case, the base portion and the lid portion are preferably made in one piece and from the same material. The integral hinge allows to either establish the open configuration or the closed configuration.

Further, it is preferred if the base portion and the lid portion, in the closed configuration, are connected via a first connection portion and a second connection portion.

In this embodiment, a longitudinal element can be held by the base portion and the lid portion in the closed configuration with high holding or retention forces.

In a further preferred embodiment, at least one of the first and the second connection portion comprises a locking nose at one of the base portion and the lid portion, and a shoulder at the other of the base portion and the lid portion.

In this embodiment, the connection portion is formed as a locking portion wherein the locking nose is adapted to positively engage the locking shoulder in the closed configuration.

The locking nose may be adapted to be deflected radially when establishing the closed configuration, and to elastically restore its state, in which it engages positively at the locking shoulder.

Further, it is preferred if the first and the second connection portion are arranged on opposite sides of the circular holding portion.

In this case, high retention forces can be achieved.

Preferably, one connection portion is arranged in the area of an integral hinge. In this case, the integral hinge may be formed by two hinge portions which are arranged at a distance from each other in a direction parallel to the extension of the longitudinal element (corresponding to a holding axis of the circular holding portion). In this case, it is preferred if the one connection portion is arranged between the two hinge portions of the integral hinge.

Further, it is preferred if the rivet protrusion comprises a shaft. Preferably the shaft is integral with the base portion.

Further, it is preferred if at least one locking tongue is provided in a region of a front tip of the shaft.

Such locking tongue may be able to engage behind a shoulder of the perforated sheet part. Particularly, the locking tongue may be formed such that, when attached to the sheet part, protrudes from a hole of the sheet part and engages a shoulder thereof. As an alternative, the locking tongue may be adapted to engage at the internal thread of the hole of the sheet part.

Further, it is preferred if the shaft has a number of annular undulations.

An outer diameter of an undulation is preferably approximately identical to an inner diameter of the internal thread of the hole of the sheet part. Further, the diameter may be a little larger than the inner diameter of the thread, so that the undulations are deformed when the rivet protrusion is inserted into the threaded hole. Therefore, high axial retention forces can be achieved.

In an alternative embodiment, the rivet protrusion comprises two rivet tongues that are radially spreadable. The rivet protrusion and the shaft can be symmetric or asymmetric.

It is in this case preferred if the base portion comprises a hole aligned with the rivet tongue, such that a pin shaft may be inserted between the rivet tongues so as to spread them radially apart from each other.

The pin may a part of the plastic clip and may be made integral with for example the base portion. The step of inserting the pin shaft into the hole and between the rivet tongues may involve ripping off a little web part which integrally connects the base portion and the pin shaft.

While in the first embodiment, the attachment of the plastic clip to the perforated sheet part is made by simply pressing the rivet protrusion into the threaded hole, the second embodiment involves a first step of inserting the rivet protrusion into the threaded hole, and involves a second step of subsequently pushing the pin shaft into the same direction, so as to insert the pin shaft between the rivet tongues and spread them radially apart. Thereby, the rivet tongues may be forced to positively engage the internal thread of the whole. The first step and the second step can preferably be performed in one single axial movement.

In another generally preferred embodiment, the plastic clip is a 2K-plastic clip and/or at least one jacket portion is made of a rubber material or a TP (thermoplastic) material, particularly a thermoplastic elastomeric material (TPE). The TPE may be a TPS material, i.e. a styrenic block copolymer.

It will be understood that the features of the application mentioned above and those yet to be explained below can be used not only in the respective combination indicated, but also in other combinations or in isolation, without leaving the scope of the present invention.

### BRIEF DESCRIPTION OF THE DRAWINGS

Exemplary embodiments of the application are explained in more detail in the following description and are represented in the drawings, in which:

FIG. 1 is a schematic sectional view of an assembly location where a fluid line is to be assembled to a vehicle body sheet;

FIG. 1a is an enlarged schematic view of a plastic clip used for attaching a fluid line to a perforated vehicle body sheet;

FIG. 2 is a perspective view of another embodiment of a plastic clip;

FIG. 3 is a side view of the plastic clip of FIG. 2 in the open configuration;

FIG. 4 is a side view of the plastic clip of FIG. 2 in the closed configuration;

FIG. 5 is a top view of the plastic clip of FIG. 4;

FIG. 6 is a sectional view along the plane VI-VI in FIG. 5;

FIG. 7 is a sectional view along a plane VII-VII in FIG. 5;

FIG. 8 is a perspective view of another embodiment of a plastic clip;

FIG. 9 is a side view of the plastic clip of FIG. 8 in an open configuration;

FIG. 10 is a side view of the plastic clip of FIG. 8 in a closed configuration;

FIG. 11 is a top view of the plastic clip of FIG. 10;

FIG. 12 is a sectional view of a plane XII-XII in FIG. 11;

FIG. 13 is a sectional view of a plane XIII-XIII in FIG. 11;

FIG. 14 is a perspective view of a pre-assembled fluid line arrangement; and

FIG. 15 is a detail XV of FIG. 14.

### DESCRIPTION

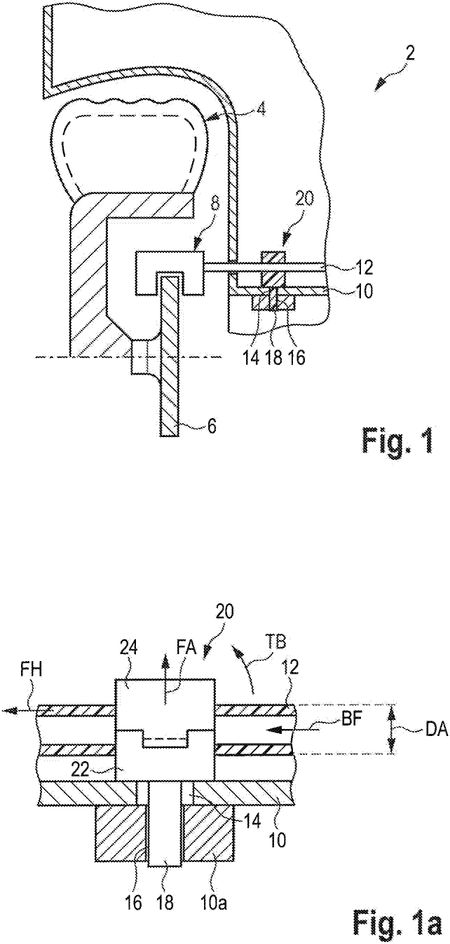

FIG. 1 is a schematic view of an area of a wheel-house of a vehicle 2. A wheel 4 is arranged within the wheel house, wherein the wheel 4 is connected to a brake disk 6.

A brake system 8 includes braking cylinders is assigned to the brake disk 6. The brake system 8 is arranged close to a vehicle body sheet (perforated sheet part) 10.

A brake line/hose (longitudinal element) 12 is connected to the brake system 8. The brake line 12 is connected by means of a plastic clip/bracket 20 to the body sheet 10. Particularly, the body sheet 10 comprises a hole 14, which is preferably provided with an inner thread 16, and the plastic clip 20 is used to connect the brake line 12 to the body sheet 10, wherein a protrusion 18 of the plastic clip 20 extends into the hole 14.

FIG. 1a shows a detail of FIG. 1.

Particularly, it is shown that the plastic clip 20 includes a base portion 22 and a lid portion 24 which are connected to each other so as to enclose and hold the brake line 12.

The brake line 12 itself is used to guide braking fluid BF. The brake line 12 has an outer diameter DA.

As is shown in FIG. 1a, a nut 10a is fixedly connected to an underside of the body sheet 10, wherein the nut 10a includes the inner thread 16. The protrusion 18 extends into the nut 10a.

The attachment of the plastic clip 20 to the body sheet 10 is such that the plastic clip 20 with the brake line 12 can be retained with an force FA of at least 400 N.

In addition, the brake line 12 is held in the plastic clip 20 such that bending torques TB of at least 1 Nm can be sustained. In addition, the brake line 12 is held in the plastic clip 20 such that axial forces FH along the extension of the brake line 12 can be resisted, which exceed 100 N.

The torque resistance of the clip 20 holding the brake line 12 is at least 1 Nm.

In the following description, further embodiments are described which correspond to the above embodiment with regard to design and function. Similar elements are given the same reference numerals. In the following, differences are described.

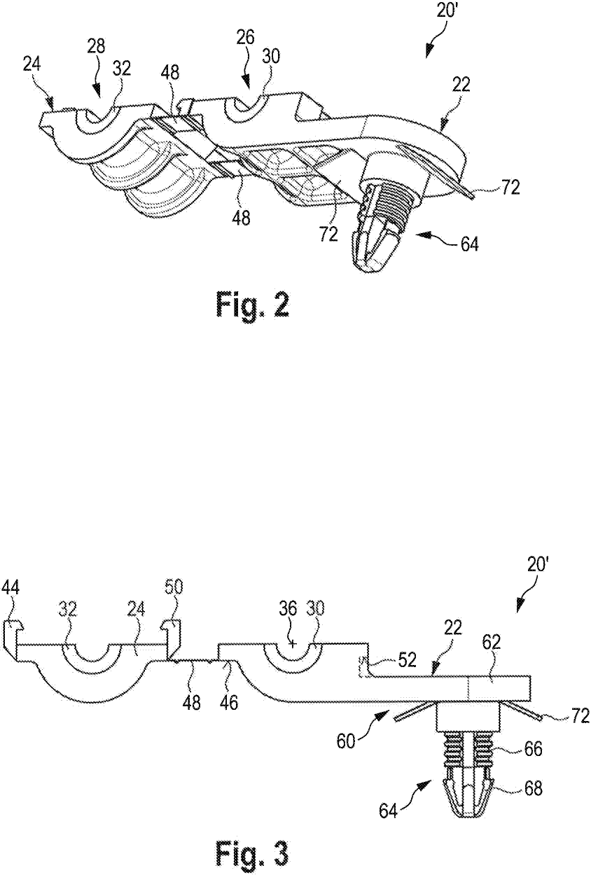

In FIGS. 2 to 7, a preferred embodiment of a plastic clip 20' is shown.

The plastic clip 20 includes a base portion 22 and a lid portion 24. The base portion 22 comprises a base receptacle 26 for the longitudinal element 12 (brake line). The lid portion 24 includes a corresponding lid receptacle 28. The receptacles 26, 28 are in each case semi-circular.

The base receptacle 26 is provided with a base jacket portion 30 which is made from a material that is softer than the material of the base receptacle 26 (base portion 22). Correspondingly, the lid receptacle 28 is provided with a lid jacket portion 32 made of the same material as the base jacket portion 30.

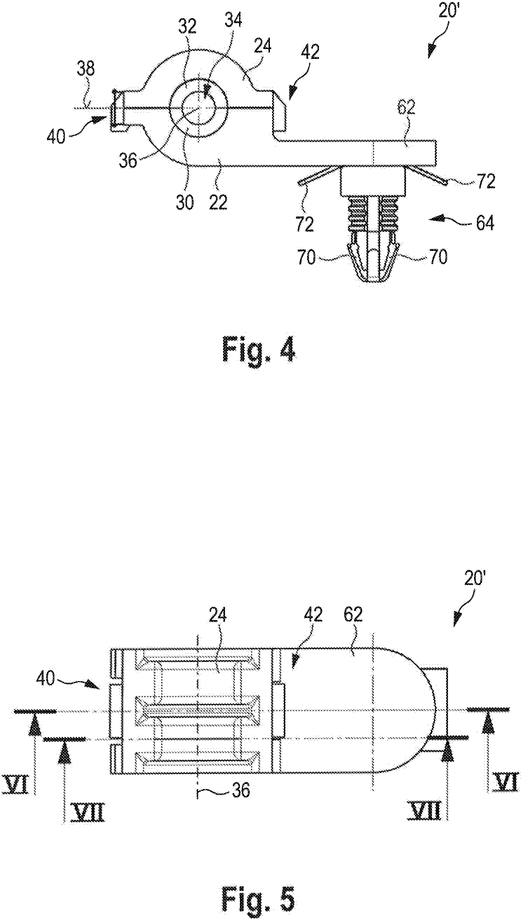

The base receptacle 26 and the lid receptacle 28, in a closed configuration as shown in FIG. 4, form a circular holding portion 34 which defines a holding axis 36 which is coaxial to the brake line 12 held therein.

The base portion 22 and the lid portion 24, in the closed configuration, contact each other along a closure plane 38. The closure plane 38 is aligned approximately parallel to an underside of the base portion 22, which is to be placed upon the sheet part 10 onto which the plastic clip 20 is to be arranged.

The base portion 22 and the lid portion 24 are connected to each other in the closed configuration by means of a first connection portion 40 and a second connection portion 42. The connection portions 40, 42 are arranged on opposite sides of the holding axis 36.

The first connection portion 40 comprises a first locking nose 44 which is a part of the lid portion 24. Further, the first connection portion 40 comprises a first locking shoulder 46 which is formed by the base portion 22.

Correspondingly, the second connection portion 42 comprises a first locking nose 44, which is a part of the lid portion 24. The second connection portion 42, further, comprises a first locking shoulder 46 which is formed by the base portion 22.

In the closed configuration, as shown for example in FIGS. 4, 6 and 7, the locking noses 44, 50 engage the respective locking shoulders 46, 52 so as to form a positive locking engagement between the base portion 22 and the lid portion 24.

An inner diameter DI of the circular holding portion 34 (FIG. 7) is preferably equal or smaller than the outer diameter DA (FIG. 1a) of the brake line. It is to be noted that the brake line 12 is one example of a longitudinal element. The plastic clip 20' can be used for holding other longitudinal elements as well.

The base portion 22 and the lid portion 24 are connected to each other by an integral hinge 48 which is best shown in FIGS. 2 and 3.

The integral hinge 48 comprises two hinge portions that are spaced from each other along an axis parallel to the holding axis 36. The first connection portion 40 is arranged between the hinge portions of the integral hinge 48.

The integral hinge 48 allows to establish an open configuration of the plastic clip 20' as shown for example in FIGS. 2 and 3, or the closed configuration of FIGS. 4, 5, 6, and 7.

The base portion 22 and the lid portion, together with the integral hinge 48, are made from a first material, preferably PA, in particular PA 66.

The jacket portions 30, 32 are preferably made of a rubber material or a thermoplastic elastomer (TPE) such as TPS.

The jacket portions 30, 32 and the remaining part of the plastic clip can be produced by means of a 2K-injection molding method. The jacket portions 30, 32 are safely held and not detachable from the respective receptacle 26, 28.

The base portion 22 comprises a support portion 60 from which a rivet protrusion 64 protrudes.

The support portion 60 is formed at the underside of an extension portion 62 of the base portion 22. The extension portion 62 is a plate like portion which extends along a plane that is essentially tangential to the holding axis 36. An underside of a main part of the base portion 22 and an underside of the extension portion 22 are formed to be contiguous.

The rivet protrusion 64 is formed such that its extension direction is tangential to the holding axis 36.

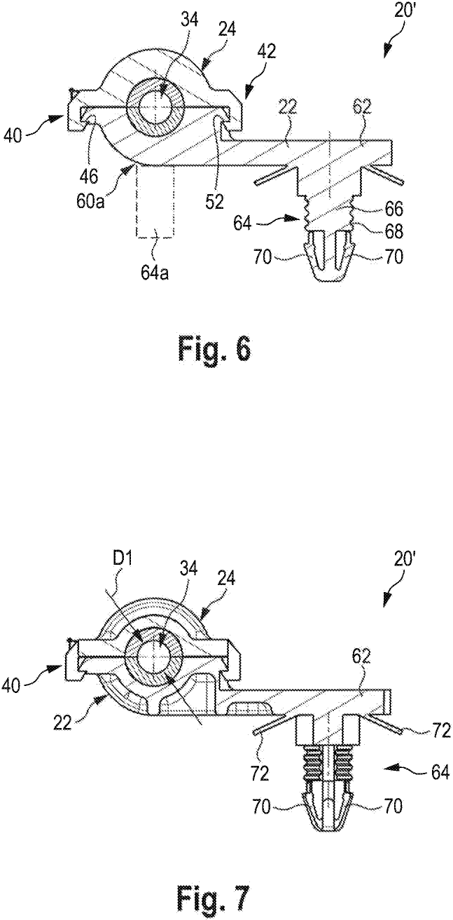

As is shown in FIG. 6, the support portion 60a may be formed directly under a main part of the base portion 22, so that the rivet protrusion 64a extends from the support portion 60 such that its extension direction intersects the holding axis 36.

In some cases, two rivet protrusions 64, 64a may be provided. In other embodiments, only one of the two rivet protrusions 64, 64a is provided.

As is shown particularly in FIGS. 6 and 7, the rivet protrusion 64 comprises a shaft 66 which is formed integral with the support portion 60.

An outer circumference of the shaft 66 is provided with annular undulations 68.

At a free end of the rivet protrusion 64, a number of locking tongues 70 are provided that can be radially deflected. Upon insertion into a threaded hole, the locking tongues 70 deflect and are urged elastically against the inner side of the thread or against a shoulder of the sheet part, so as to establish a locking connection between the rivet protrusion 64 and the threaded hole 14.

The support portion 60 may include at least one wing 72. In the present case, two wings 72 are provided on opposite sides of the rivet protrusion 64. The wings are axially elastically deflectable. When inserting the rivet protrusion 64 into the threaded hole 14, the wings 72 deflect against the upper side of the sheet part 10 and provide a pre-tension for the locking engagement between the locking tongues 70 and the internal thread of the hole 14.

It is to be noted that the wings 72 are optional in this case.

The plastic clip 20 can be used to form a pre-assembled brake line arrangement as will be described later.

Particularly, the plastic clip 20 can be attached to a brake line at a certain pre-defined attachment position along the extension of the brake line. During assembly of the brake line to a vehicle, the plastic clip is already in the correct axial position and may be turned slightly around the holding axis in order to insert the rivet protrusion 64 into a threaded hole of the perforated sheet part, particularly of a vehicle body sheet part.

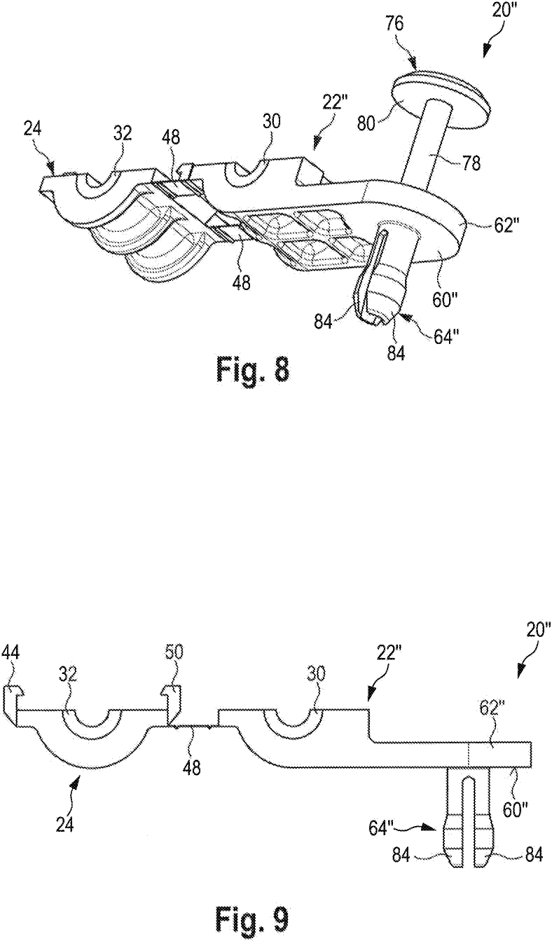

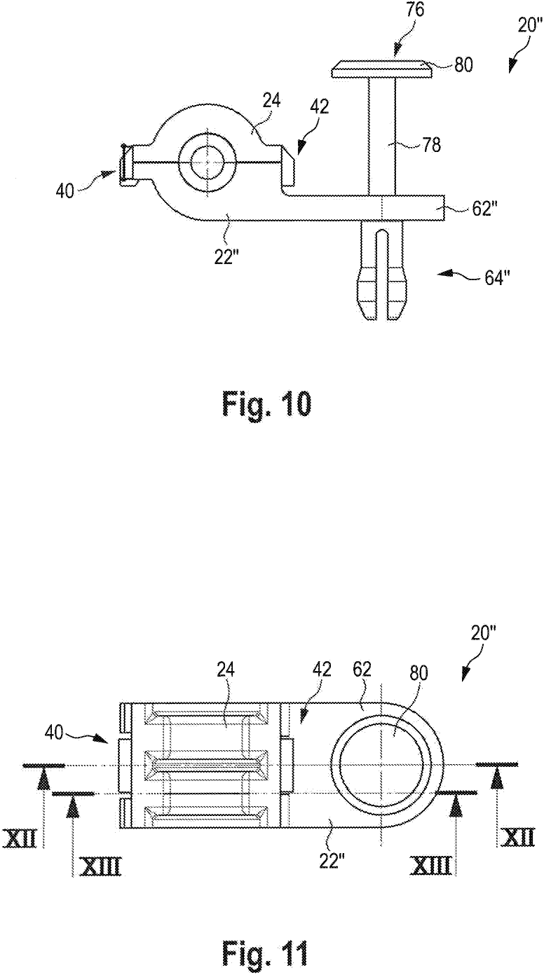

FIGS. 8 to 13 show an alternative embodiment of a plastic clip 20" which corresponds with regard to design and function generally to the plastic clip 20' of FIGS. 3 to 7. Same elements are therefore assigned identical reference numerals. In the following, mainly the differences are described.

The plastic clip 20" is identical to the plastic clip 20' regarding its circular holding portion 34 which is formed by the receptacle 26, 28 and the respective jacket portions 30, 32. Also, the base portion 22 and the lid portion 24 are connected to each other via an integral hinge.

While the embodiment of FIGS. 3 to 7 includes a solid shaft 66, the rivet protrusion 64" of the plastic clip 20" includes two rivet tongues 84.

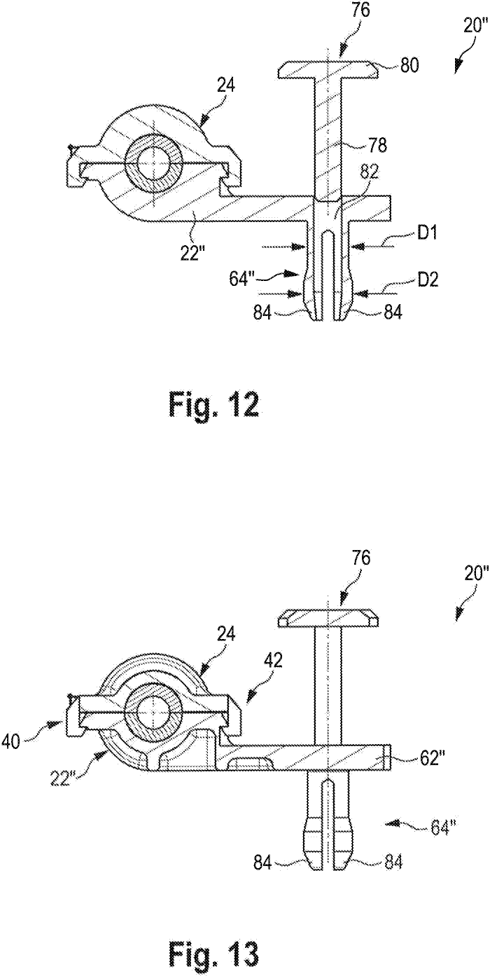

A pin hole 82 is provided in the base portion 22, particularly in the extension portion 62" thereof. A pin shaft 78 of pin 76 is partly inserted into the pin hole 82, as is particularly shown in FIG. 12.

When manufacturing the plastic clip, the pin 76 may be co-injected, such that it is connected via at least one small web to the extension portion 62". In other embodiments, the pin 76 may be a separate part.

The pin 76 may have a pin head 80 with an enlarged diameter, or may be a simple pin with a uniform outer diameter.

The rivet tongues 84 have a first section which extends from the extension portion 62" to approximately a middle part thereof, and a second section which is formed by the free ends of the rivet tongues 84.

In the first section, the rivet tongues essentially define an internal diameter which corresponds to the outer diameter of the pin shaft 78. Therefore, the pin shaft 78 can be inserted through the pin hole 82 and into the rivet tongues without deflecting the rivet tongues 84.

In the second section, which is formed by the free end of the rivet tongues 84, an internal diameter defined by the rivet tongues 84 is smaller than an outer diameter of the pin shaft 78. When the pin shaft 78 reaches the second section, the rivet tongues 84 are spread radially apart from each other. In this case, the radially outer sides of the rivet tongues 84 engage the internal thread 16 so as to fix the clip 20” to the sheet part 10.

In the second section, the outer diameter D2 is larger than the outer diameter D1 in the first section of the rivet tongues 84.

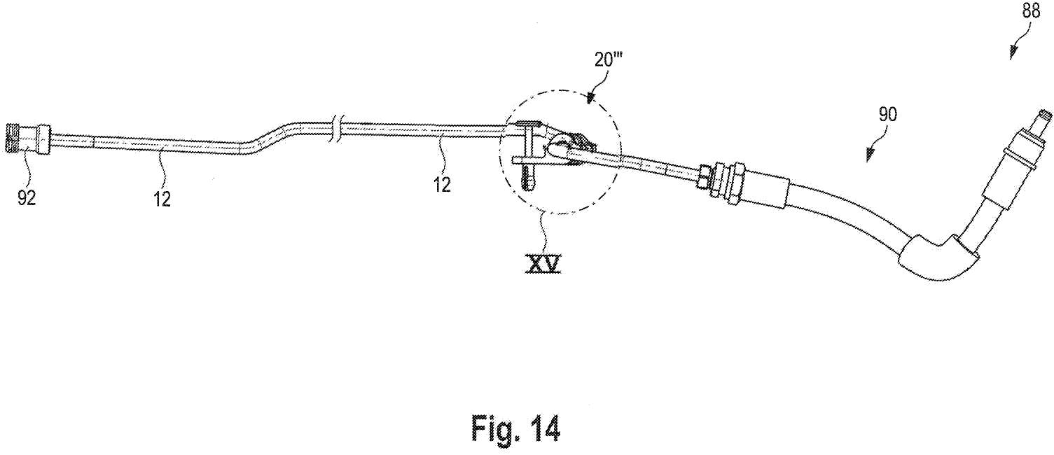

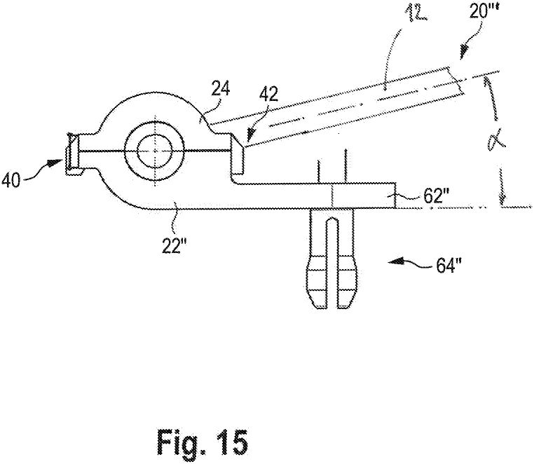

In FIGS. 14 and 15 there is shown a pre-mounted brake line arrangement 88 which includes a brake line 12, a first brake line connector 90 attached to one end of the brake line 12 and a second brake line connector 92 attached to a second end of the brake line 12.

In an area between the first and second connectors 90, 92, a plastic clip 20"' is pre-mounted to the brake line 12.

The plastic clip 20'" may be formed by any of the above described plastic clips 20, 20', 20". The plastic clip 20'" is preferably identical to the plastic clip of FIGS. 8 to 13.

The plastic clip 20'" is mounted to the brake line 12 such that a certain part of the brake line 12 is arranged under an angle α of larger than 0° and smaller than 45° with respect to a plane that is defined by the extension portion 62"’.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### Reference Number List

2 vehicle

4 wheel

6 brake disk

8 brake system

10 vehicle body sheet (perforated sheet part)

10a nut

12 brake line/hose (longitudinal element)

14 hole

16 inner thread

18 protrusion

20 plastic clip/bracket

22 base portion

24 lid portion

26 base receptacle

28 lid receptacle

30 base jacket portion

32 lid jacket portion

34 circular holding portion

36 holding axis

38 closure plane

40 first connection portion 22/24

42 second connection portion 22/24

44 first locking nose of 40

46 first locking shoulder of 22

48 integral hinge

50 second locking nose of 42

52 second locking shoulder of 22

60 support portion of 22

62 extension portion of 22

64 rivet protrusion

66 shaft

68 annular undulations

70 locking tongues

72 wings

76 pin

78 pin shaft

80 pin head

82 pin hole in 22

84 rivet tongues

88 Pre-mounted brake line arrangement

90 first brake line connector

92 second brake line connector

94 protection wall portion of 22"'

BF braking fluid

DA outer diameter 12

DI inner diameter 34

FH axial holding force

TB bending torque

FA attachment force

D1 first outer diameter 64"

D2 second outer diameter 64"

α angle

1. A plastic clip for attaching a longitudinal element to a perforated sheet part, comprising:
a base portion; and
a lid portion connectable or hingedly connected to the base portion so as to establish an open configuration or a closed configuration,
wherein the base portion has a semi-circular base receptacle for the longitudinal element,
wherein the lid portion has a semi-circular lid receptacle for the longitudinal element, wherein the base receptacle and the lid receptacle, in the closed configuration, together form a circular holding portion for the longitudinal element,
wherein at least one of the base receptacle and the lid receptacle is provided with a jacket portion which is made from a material that is softer than the material of the respective receptacle,
wherein the base portion comprises a support portion from which projects a plastic rivet protrusion adapted to be inserted into a hole of the perforated sheet part.

2. The plastic clip according to claim 1, wherein at least one of:
(i) the support portion is provided at an underside of a main part of the base portion; and
(ii) the support portion is provided at an extension portion of the base portion.

3. The plastic clip according to claim 1, wherein the base portion and the lid portion are connected via an integral hinge.

4. The plastic clip according to claim 1, wherein the base portion and the lid portion, in the closed configuration, are connected via a first connection portion and a second connection portion.

5. The plastic clip according to claim 4, wherein at least one of the first and the second connection portions comprises a locking nose at one of the base portion and the lid portion, and a locking shoulder at the other of the base portion and the lid portion.

6. The plastic clip according to claim 4, wherein the first and the second connection portions are arranged on opposite sides of the circular holding portion.

7. The plastic clip according to claim 1, wherein the rivet protrusion comprises a shaft.

8. The plastic clip according to claim 7, wherein at least one locking tongue is provided in a region of a front tip of the shaft.

9. The plastic clip according to claim 7, wherein the shaft has a number of annular undulations.

10. The plastic clip according to claim 1, wherein the rivet protrusion comprises two rivet tongues that are radially spreadable.

11. The plastic clip according to claim 10, wherein the base portion comprises a hole aligned with the rivet tongues such that a pin shaft may be inserted between the rivet tongues so as to spread them radially apart from each other.

12. The plastic clip according to claim 1, wherein the plastic clip is a 2K-plastic clip.

13. The plastic clip according to claim 1, wherein at least one jacket portion is made of a rubber material or a TP material.

14. A pre-assembled fluid line arrangement comprising a fluid line for guiding a fluid and at least one plastic clip, the plastic clip comprising:
a base portion; and
a lid portion connectable or hingedly connected to the base portion so as to establish an open configuration or a closed configuration,
wherein the base portion has a semi-circular base receptacle for the longitudinal element,
wherein the lid portion has a semi-circular lid receptacle for the longitudinal element, wherein the base receptacle and the lid receptacle, in the closed configuration, together form a circular holding portion for the longitudinal element,
wherein at least one of the base receptacle and the lid receptacle is provided with a jacket portion which is made from a material that is softer than the material of the respective receptacle,
wherein the base portion comprises a support portion from which projects a plastic rivet protrusion adapted to be inserted into a hole of the perforated sheet part, and
wherein the plastic clip is closed so that the circular holding portion encloses the fluid line and is pre-mounted thereto at a pre-defined attachment position along the extension of the fluid line.

15. A method of attaching a longitudinal element to a perforated sheet part, comprising the steps of:
providing a plastic clip and pre-mounting the plastic clip to the longitudinal element; and
attaching the plastic clip to the perforated sheet part,
wherein the plastic clip comprises:
a base portion; and
a lid portion connectable or hingedly connected to the base portion so as to establish an open configuration or a closed configuration,
wherein the base portion has a semi-circular base receptacle for the longitudinal element,
wherein the lid portion has a semi-circular lid receptacle for the longitudinal element, wherein the base receptacle and the lid receptacle, in the closed configuration, together form a circular holding portion for the longitudinal element,
wherein at least one of the base receptacle and the lid receptacle is provided with a jacket portion which is made from a material that is softer than the material of the respective receptacle,
wherein the base portion comprises a support portion from which projects a plastic rivet protrusion adapted to be inserted into a hole of the perforated sheet part, and
wherein the attachment step includes inserting the rivet protrusion into a hole of the perforated sheet part.
